(19) United States
(12) Patent Application Publication
(10) Pub. No.: US 2006/0148959 A1
(43) Pub. Date: Jul. 6, 2006

(54) Process for preparing polymer nanocomposites and nanocomposites prepared therefrom

(76) Inventors: Avraam Isayev, Akron, OH (US); Sergey Lapshin, Akron, OH (US)

Correspondence Address: ROETZEL AND ANDRESS, 222 SOUTH MAIN STREET, AKRON, OH, 44308, US

(21) Appl. No.: 11/294,738

(22) Filed: Dec. 6, 2005

Related U.S. Application Data
(60) Provisional application No. 60/633,533, filed on Dec. 6, 2004.

(51) Int. Cl. C08K 9/04

(52) U.S. Cl. 524/445

(57) ABSTRACT

In one embodiment, the present invention relates to a continuous method of forming a polymer nanoparticle composite, the method comprising: (a) combining at least one polymer and at least one type of nanoparticles to form a polymer nanoparticle mixture; and (b) subject the polymer nanoparticle mixture to an energy source, wherein the energy source has a frequency in the range of about 15 KHz to about 200 MHz, wherein the polymer nanoparticle mixture is in a melted state and wherein the polymer nanoparticle mixture is subjected to the energy source for less than 60 seconds.

### RELATED APPLICATION DATA

This application claims priority to previously filed U.S. Provisional Application No. 60/633,533, filed on Dec. 6, 2004, entitled “Continuous Process for Melt Intercalation of PP-Clay Nanocomposites with Aid of Power Ultrasound,” which is hereby incorporated by reference in its entirety.

### FIELD OF THE INVENTION

The present invention relates to nanocomposites and a process for preparing polymer nanocomposites (e.g., a continuous process). More particularly, the present invention relates to polymer nanocomposites containing a combination of one or more polymers (e.g., one or more polyolefins) with one or more types of nanoparticles, and to methods to produce such nanocomposites. In one embodiment, the present invention relates to polypropylene nanocomposites wherein organoclay particles are intercalated with a polypropylene polymer.

### BACKGROUND OF THE INVENTION

Nanocomposites are a class of materials that can address many of the challenges currently presented by plastics and composites needs. These materials offer a variety of desirable physical, chemical and mechanical properties including, but not limited to, low coefficient of thermal expansion, high heat deflection temperatures, lightweight, improved scratch resistance, and potential application in, for example, automotive Class A surfaces. Nanocomposites are polymers reinforced with nanometer sized particles. These materials can be used in a wide range of applications. For example, possible automotive applications include, but are not limited to, structural, semi-structural, high heat underhood, and Class A automotive components. Polyolefin based nanocomposites, in particular, have long been sought after due to polyolefin's wide usage and low resin cost. The major difficulty lies in generating a well-dispersed, well-exfoliated sample due to differences in polarity and compatibility between the clay and polymer phases.

Polymer-layered silicate nanocomposites incorporate a clay filler in a polymer matrix. Two groups of clay are currently recognized—the kaolin group and the montmorillonite group. The molecules of the kaolin are arranged in two sheets or plates, one of silica and one of alumina. Similarly, montmorillonite clays are arranged in two silica sheets and one alumina sheet. The molecules of the montmorillonite clays are less firmly linked together than those of the kaolin group and are thus further apart.

Typically, polymer nanocomposites combine an organic polymer with an inorganic layered silicate (e.g., thermoplastic Nylon 6 and a montmorillonite clay). Layered silicates are made up of several hundred thin platelet layers stacked into an orderly packet known as a tactoid. Each of these platelets is characterized by large aspect ratio (diameter/thickness on the order of 100-1000). Accordingly, when the clay is dispersed homogeneously and exfoliated as individual platelets throughout the polymer matrix, dramatic increases in strength, flexural and Young's modulus, and heat distortion temperature are observed at very low filler loadings (generally less than 10% by weight) due to the large surface area contact between polymer and filler. The Nylon 6 nanocomposites known to those of skill in the art are generally produced by intercalation of caprolactam monomers into the silicate galleries and then in situ polymerization of the monomers. While melt compounding of Nylons with organically modified clays (nanoclays) has also been attempted, the mechanical properties and degree of clay dispersion and exfoliation are slightly short of those of the in situ polymerized type. Efforts to generate similar nanocomposites using other types of thermoplastics and thermosets have enjoyed varying degrees of success.

Due to the polar nature of layered silicates, attempts to generate nanocomposites in a non-polar polyolefin matrix have been only marginally successful. Many research groups have attempted melt compounding of polypropylene and polyethylene based nanocomposites by adding maleic anhydride grafted polypropylene oligomers (PP-MA) to aid in compatibilization and dispersion. While this strategy is somewhat effective in improving nanoclay exfoliation, it requires almost 25% PP-MA, which has the deleterious effect of softening the matrix. To circumvent this issue, a few groups have attempted intercalation of olefin monomers and in situ polymerization to generate polyolefin-silicate nanocomposites. In 1996, Tudor attempted in situ polypropylene polymerization with a Ziegler-Natta catalyst, which produced oligomers, but did not succeed in producing an intercalated or exfoliated structure due to catalyst instability. (see J. Tudor et al., Chemical Communications, 1996, vol. 17, pp. 2031-32.) In 1999, Bergman was able to generate an exfoliated polyethylene by in situ polymerization with a new class of catalyst. (see Bergman, J. S., et al., Chemical Communications, 1999, vol. 21, pp. 2179-2180).

In spite of the large number of researchers working on preparation of polypropylene-clay nanocomposites no direct intercalation of a polypropylene polymer in simple organically modified layered silicates has been observed due to polymeric matrix apolarity. Two different techniques have been tried to overcome this problem.

As is discussed above, the first one is functionalization of the polypropylene chain by maleic anhydride or even by hydroxyl groups. Although this method has proved capable of forming nanocomposites, the exfoliation of the clays silicate layers is incomplete and thus, the reinforcement effect is limited. This is especially true for polyolefins like high density polyethylene (HDPE).

In the second technique a commercially available organoammonium-exchanged montmorillonite is modified using an organic swelling agent (whose boiling point is situated between 100 and 200° C., such as ethylene glycol, naphtha or heptane) in order to increase the interlayer spacing. The swollen organoclay is then compounded with polypropylene in a twin-screw extruder at 250° C. The swelling agent is volatized during the extrusion process, leading to the formation of a nanocomposite. As one can see, both methods utilize additional chemicals, and the second method is not very environmentally friendly.

Thus, for at least the above reasons, there exists a need for an improved process for dispersing and exfoliating filler material in a polymer matrix.

### SUMMARY OF THE INVENTION

The present invention relates to nanocomposites and a process for preparing polymer nanocomposites (e.g., a continuous process). More particularly, the present invention relates to polymer nanocomposites containing a combination of one or more polymers (e.g., one or more polyolefins) with one or more types of nanoparticles, and to methods to produce such nanocomposites. In one embodiment, the present invention relates to polypropylene nanocomposites wherein organoclay particles are intercalated with a polypropylene polymer.

In one embodiment, the present invention relates to a continuous method of forming a polymer nanoparticle composite, the method comprising: (a) combining at least one polymer and at least one type of nanoparticles to form a polymer nanoparticle mixture; and (b) subjecting the polymer nanoparticle mixture to an energy source, wherein the energy source has a frequency in the range of about 15 KHz to about 200 MHz, wherein the polymer nanoparticle mixture is in a melted state and under pressure in Step (b), and wherein the polymer nanoparticle mixture is subjected to the energy source for less than about 60 seconds.

In another embodiment, the present invention relates to a continuous method of forming a polymer nanoparticle composite, the method comprising: (a) combining at least one polymer and at least one type of nanoparticles to form a polymer nanoparticle mixture; and (b) subjecting the polymer nanoparticle mixture to an energy source, wherein the energy source has a frequency in the range of about 15 KHz to about 200 MHz, wherein the polymer nanoparticle mixture is in a melted state and under pressure in Step (b), and wherein the polymer nanoparticle mixture is subjected to the energy source for less than about 30 seconds.

### BRIEF DESCRIPTION OF THE DRAWINGS

FIG. 1 is a graph of power consumption as a function of flow rate at different concentrations of Cloisite® 15A (open symbols) and Cloisite® 20A (solid symbols);

FIG. 2 is a graph of die pressure as a function of flow rate at different concentrations of Cloisite® 15A (open symbols) and Cloisite® 20A (solid symbols);

FIG. 3A is a graph of complex viscosity as a function of frequency for polypropylene containing 10% by weight of Cloisite® 15 based on the total weight of the polymer mixture, the samples being both untreated (one sample) and treated (three samples) by ultrasound at different flow rates;

FIG. 3B is a graph of complex viscosity as a function of frequency for polypropylene containing 10% by weight of Cloisite® 15 based on the total weight of the polymer mixture, the samples being both untreated (one sample) and treated (three samples) by ultrasound at different flow rates;

FIG. 4A is a graph of XRD patterns of untreated and ultrasonically treated polypropylene based nanocomposites containing 2.5% by weight Cloisite® 15A, based on the total weight of the polymer mixture, prepared at different flow, as well as neat Cloisite® 15A (2θ values are indicated in parentheses);

FIG. 4B is a graph of XRD patterns of untreated and ultrasonically treated polypropylene based nanocomposites containing 2.5% by weight Cloisite® 20A, based on the total weight of the polymer mixture, prepared at different flow, as well as neat Cloisite® 20A (2θ values are indicated in parentheses);

FIG. 5A is a TEM image of an untreated polypropylene nanocomposite containing 2.5% by weight Cloisite® 20A, based on the total weight of the polymer mixture;

FIG. 5B is a TEM image of a polypropylene nanocomposite containing 2.5% by weight Cloisite® 20A, based on the total weight of the polymer mixture, treated ultrasonically, in accordance with one embodiment of the present invention, at a flow rate of 0/25 g/s;

FIG. 6A is a graph illustrating Young's modulus as a function of flow rate for polypropylene and polypropylene nanocomposites containing various concentrations of Cloisite® 15A;

FIG. 6B is a graph illustrating Young's modulus as a function of flow rate for polypropylene and polypropylene nanocomposites containing various concentrations of Cloisite® 20A;

FIG. 7 is a graph illustrating TGA curves for polypropylene and polypropylene nanocomposites containing various concentrations of Cloisite® 20A that have been ultrasonically treated, in accordance with one embodiment of the present invention, at a flow rate of 0/25 g/s;

FIG. 8 is a graph of power consumption as a function of flow rate for both neat polypropylene and polypropylene/Cloisite® 20A nanocomposites obtained by single stage processes (starved or flood fed) and a two stage process;

FIG. 9 is a graph of die pressure as a function of flow rate for neat polypropylene and polypropylene/Cloisite® 20A nanocomposites obtained by single stage processes (starved or flood fed) and a two stage process;

FIG. 10A is a graph of complex viscosity as a function of frequency for both treated and untreated polypropylene nanocomposites containing 2.5% by Cloisite® 20A prepared by a two stage process;

FIG. 10B is a graph of complex viscosity as a function of frequency for both treated and untreated polypropylene nanocomposites containing 2.5% by Cloisite® 20A prepared by a single stage starved feeding process;

FIG. 10C is a graph of complex viscosity as a function of frequency for both treated and untreated polypropylene nanocomposites containing 2.5% by Cloisite® 20A prepared by a single stage flood feeding process with a gap size of 4 mm;

FIG. 10D is a graph of complex viscosity as a function of frequency for both treated and untreated polypropylene nanocomposites containing 2.5% by Cloisite® 20A prepared by a single stage flood feeding process with a gap size of 2 mm;

FIG. 11A is a graph of XRD patterns of untreated and ultrasonically treated polypropylene based nanocomposites containing 2.5% by weight of Cloisite® 20A, based on the total weight of the polymer mixture, prepared by a two stage, as well as neat Cloisite® 20A (2θ values are indicated in parentheses);

FIG. 11B is a graph of XRD patterns of untreated and ultrasonically treated polypropylene based nanocomposites containing 2.5% by weight of Cloisite® 20A, based on the total weight of the polymer mixture, prepared by a single stage starved feeding process, as well as neat Cloisite® 20A (2θ values are indicated in parentheses);

FIG. 11C is a graph of XRD patterns of untreated and ultrasonically treated polypropylene based nanocomposites containing 2.5% by weight of Cloisite® 20A, based on the total weight of the polymer mixture, prepared by a single stage flood feeding process with a gap size of 4 mm, as well as neat Cloisite® 20A (2θ values are indicated in parentheses);

FIG. 11D is a graph of XRD patterns of untreated and ultrasonically treated polypropylene based nanocomposites containing 2.5% by weight of Cloisite® 20A, based on the total weight of the polymer mixture, prepared by a single stage flood feeding process with a gap size of 2 mm, as well as neat Cloisite® 20A (2θ values are indicated in parentheses);

FIG. 12 is a graph of elongation at break values as a function of flow rate for polypropylene and polypropylene nanocomposites containing 2.5% by weight of Cloisite® 20A, based on the total weight of the polymer mixture prepared by single stage process (starved or flood fed) and a two stage process;

FIG. 13 is a graph of die pressure as a feeding rate (g/s) at different concentrations of Cloisite® 20A in HDPE, including 0% by weight clay, at an ultrasonic amplitude of 10 μm;

FIG. 14 is a graph of die pressure as a function of ultrasonic amplitude at different concentrations of Cloisite® 20A in HDPE, including 0% by weight clay, at a feeding rate (aka flow rate) of 0.5 g/s;

FIG. 15 is a graph of power consumption as a function of feeding rate at different concentrations of Cloisite® 20A in HDPE, including 0% by weight clay, at an ultrasonic amplitude of 10 μm;

FIG. 16A is a graph of yield stress as a function of ultrasonic amplitude at different concentrations of Cloisite® 20A in HDPE, including 0% by weight clay, at an feeding rate of 0.5 g/s;

FIG. 16B is a graph of yield strain as a function of ultrasonic amplitude at different concentrations of Cloisite® 20A in HDPE, including 0% by weight clay, at an feeding rate of 0.5 g/s;

FIG. 17 is a graph of elongation at break as a function of ultrasonic amplitude at different concentrations of Cloisite® 20A in HDPE, including 0% by weight clay, at an feeding rate of 0.5 g/s;

FIG. 18 is a graph of the toughness of various nanocomposites, prepared in accordance with one embodiment of the present invention, as a function of ultrasonic amplitude at different concentrations of Cloisite® 20A in HDPE, including 0% by weight clay, at an feeding rate of 0.5 g/s;

FIG. 19 is a graph of the complex viscosity of various nanocomposites, prepared in accordance with one embodiment of the present invention, as a function of frequency at different concentrations of Cloisite® 20A in HDPE, including 0% by weight clay, at various ultrasonic amplitudes and a feeding rate of 0.5 g/s;

FIG. 20A is a graph of storage modulus G′ as a function of frequency at different ultrasonic amplitudes in nanocomposites containing 10% by weight Cloisite® 20A and a feeding rate of 0.5 g/s; and

FIG. 20B is a graph of loss modulus G″ as a function of frequency at different concentrations of Cloisite® 20A, without ultrasound, and a feeding rate of 0.5 g/s.

### DETAILED DESCRIPTION OF THE INVENTION

The present invention relates to nanocomposites and a process for preparing polymer nanocomposites (e.g., a continuous process). More particularly, the present invention relates to polymer nanocomposites containing a combination of one or more polymers (e.g., one or more polyolefins) with one or more types of nanoparticles, and to methods to produce such nanocomposites. In one embodiment, the present invention relates to polypropylene nanocomposites wherein organoclay particles are intercalated with a polypropylene polymer.

In one embodiment, the polymer used in the present invention is at least one thermoplastic polymer or co-polymer. Suitable thermoplastic polymers include, but are not limited to, polyolefin-based polymers, polystyrene-based polymers, polycarbonate polymers, polyamide polymers, or a mixture of two or more thereof. In another embodiment of the present invention, the thermoplastic polymer used herein is a polyethylene homopolymer, a polyethylene copolymer, a polypropylene homopolymer, or a polypropylene copolymer.

In still another embodiment, the polymer used in the present invention is at least one polyolefin polymer. Such polymers include, but are not limited to, polyethylene, polypropylene, polybutenes, polyisoprene, and co-polymers of two or more different polyolefin polymers. In one embodiment, the polymer used in the present invention is polypropylene (PP). In another embodiment, the polymer used in the present invention is polyethylene. In still another embodiment, the polymer used in the present invention is high density polyethylene (HDPE). In still another embodiment, the polymer used in the present invention is at least one elastomeric polymer or co-polymer (e.g., a styrene-butadiene copolymer, a neoprene, a polyurethane rubber, etc.).

In one embodiment, the nanoparticles used in the present invention are a clay, an organoclay, or a modified clay. In one embodiment, the nanoparticles used in the present invention are a clay and/or an organoclay. In still another embodiment, the nanoparticles of the present invention include, but are not limited to, montmorillonite clay, kaolin clay, calcium carbonate, titanium dioxide, talc, zirconium dioxide, zinc oxide, calcium silicate, aluminum silicate, calcium sulfate, alumina trihydrate, glass nanofibers, carbon nanofibers and/or nanotubes, and mixtures of two or more thereof. Suitable montmorillonite clays include Cloisite® 15A and 20A (available from Southern Clay Products, Inc), I.30E (commercially available from Nanocor, Inc.). These alkyl ammonium cation exchanged montmorillonite clays can also be referred to as nanoclays. The Southern Clay Products nanoclay is cation exchanged with excess amine, while the Nanocor nanoclays are rinsed of excess salts and purified. In a variation of the present invention, the nanoparticles are a mixture of a nanoclay and one or more traditional fillers. Such traditional fillers include, but are not limited to, calcium carbonate, titanium dioxide, talc, zirconium dioxide, zinc oxide, calcium silicate, aluminum silicate, calcium sulfate, alumina trihydrate, glass fibers, carbon fibers, and mixtures or two or more thereof.

In one embodiment, the amount of particles/nanoparticles used in the present invention ranges from about 0.1% to about 30% of the total weight of the polymer mixture, or from about 1% to about 25% of the total weight of the polymer mixture, or from about 2.5% to about 20% of the total weight of the polymer mixture, or from about 5% to about 15% of the total weight of the polymer mixture, or even from about 7.5% to about 10% of the total weight of the polymer mixture. Here and elsewhere in the specification and claims different range limits may be combined.

In one embodiment, the diameter or length of the particles, nanoparticles, nanofibers and/or nanotubes, depending upon the geometry of the specific nanoparticle chosen, ranges from about 1 nanometer to about 20,000 nanometers, or from about 10 nanometers to about 10,000 nanometers, or from about 20 nanometers to about 5,000 nanometers, or from about 30 nanometers to about 2,500 nanometers, or from about 40 nanometers to about 1,000 nanometers, or from about 50 nanometers to about 500 nanometers, or even from about 60 nanometers to about 250 nanometers. The thickness of the particles/nanoparticles used in the present invention ranges from about 0.1 nanometer to about 5 nanometers, or from about 0.5 nanometers to about 3 nanometers, or even from about 1 nanometer to about 2.5 nanometers. Again, here and elsewhere in the specification and claims different range limits may be combined.

In one embodiment, the process of the present invention is a continuous process. In such a continuous process, a single stage or two stage extrusion process can be used.

The following specific examples are exemplary in nature and the present invention is not limited thereto.

Polypropylene Examples—Set I:

Materials and Experimental Procedures:

In the following examples polypropylene, made by Basell under trade name Profax® 6523, having an M_{w} equal to 351,000 is used to form nanocomposites in accordance with one embodiment of the present invention. Cloisite® 15A and Cloisite® 20A, natural montmorillonites modified with a quaternary ammonium salt with a cation exchange capacity of 125 meq/100 g and 95 meq/100 g, respectively, are also utilized. Polypropylene/clay nanocomposites using both Cloisite® 15A and Cloisite® 20A with varying clay contents of 2.5%, 5.0%, 10.0% by weight clay, based on the total weight of the polymer mixture, are prepared as detailed below.

A two stage process is utilized to produce the desired polypropylene/clay nanocomposites. In the first stage a co-rotating twin screw extruder (JSW Labotex 30) is used to compound polypropylene and clay. The screw speed is set at 240 rpm and zone temperatures of 100/190/180/180/175/175/175/190° C. are used. The extrudates are water-cooled and pelletized. In the second stage the material is treated with ultrasound energy (20 KHz) in the molten state in a single screw extruder. Two ultrasound horns with 4 mm gap size and 10 μm ultrasound amplitude are used. Three different flow rates of the material (0.25, 0.5, and 0.75 g/s) are realized to vary residence time.

Using a Rigaku X-ray machine operated at 40 kV and 150 mA, X-ray diffraction (XRD) patterns are obtained to determine the mean interlayer spacing of the (001) plane (d₀₀₁) for the organoclays and the nanocomposites containing the above-mentioned polypropylene. Transmission electron microscopy (TEM) is used to confirm the morphology development estimated by XRD. Ultrathin sections of specimens are cut by cryoultramicrotome below the glass transition temperature of the polypropylene, to ascertain the rigidity of the specimen, using a Reichert Ultracut's low-temperature sectioning system equipped with a diamond knife. Thin sections of specimen (approximately 70 nm) are transferred to a copper grid. A transmission electron microscopy (TECNAI 12, Philips) operated at 120 kV is used to take pictures of the specimens.

Tensile bars are obtained by Van Dorn 55 HPS 2.8F injection molding machine under the following processing conditions: a melt temperature of 190° C., a mold temperature of 25° C., an injection speed of 40 mm/s, an injection pressure of 10 MPa, a holding time of 2 seconds, and a total cycle time of 30 seconds. Tensile measurements on the injection molded samples of the above-mentioned nanocomposites are performed according ASTM D-638-00 using an Instron test machine, Model 5567. Tests are carried out at a crosshead speed of 50 mm/min and a 1 kN load cell without use of an extensiometer. All tests are performed at room temperature and the results are the average of five measurements. The highest value of standard deviation is about 7%. Also the rheological properties of nanocomposites are measured at 200° C. by ARES (Advanced Rheometric Expansion System). The geometry is a parallel plate with 25 mm diameter and 1.5 mm gap size.

Thermal gravimetric analysis (TGA) is performed on Mettler Toledo thermal analyzer, model TGA/SDT 851e, at 20° C./min heating rate in nitrogen flow.

Process Characteristics:

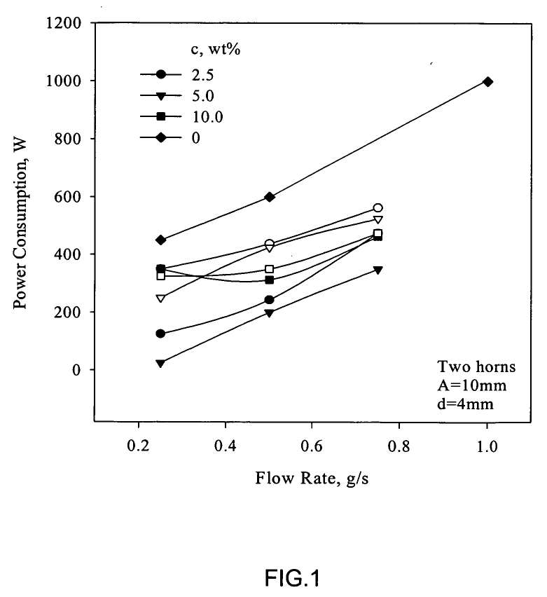

The recorded power consumption is the total power consumption, a part of which is dissipated as heat while a part is utilized to disperse clay filler and promote polymer intercalation into the clay inter gallery spacing. While not wishing to be bound to any one theory, it is not possible to determine exactly what proportion of the power is dissipated as heat and exactly what portion of the power is utilized to disperse the clay filler and promote polymer intercalation into the clay inter gallery spacing. The only thing that can be recorded is the initial power consumption of the system when the ultrasound horn is at work without a load and this loss is subtracted from the recorded values of power consumption to give the values shown in FIG. 1. Specifically, FIG. 1 is a graph of power consumption as a function of flow rate at different concentrations of Cloisite® 15A (open symbols) and Cloisite® 20A (solid symbols). The sample containing no clay (0% by weight) is shown only as a solid symbol line.

An increased flow rate generally leads to an increase in power consumption. This is an indication that more energy is being transmitted into the system at higher flow rates. As can be seen from FIG. 1, the treatment of pure polypropylene requires higher energy than that of nanocomposites. Among two Cloisites, the one with more concentrated surface modifier (15A) shows higher power consumption, which is in a good agreement with the higher die pressure required to sustain flow, as will be described below.

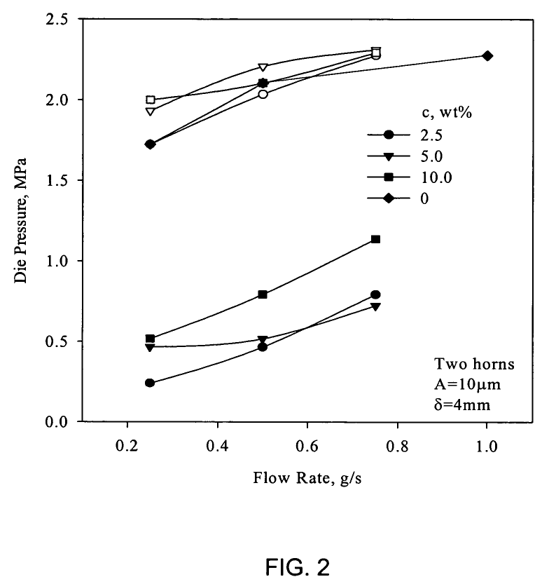

Turning to FIG. 2, FIG. 2 is a graph of die pressure as a function of flow rate at different concentrations of Cloisite® 15A (open symbols) and Cloisite® 20A (solid symbols). Again, the sample containing no clay (0% by weight) is shown only as a solid symbol line. As can be seen from FIG. 2, die pressure increases as the flow rate increases. This is because the die pressure characterizes the resistance to flow and it is a function of the average residence time of the polymer (or polymer composite) in the treatment zone. Thus, the residence time is inversely proportional to the melt flow rate. It is seen that polypropylene/Cloisite® 15A nanocomposites show much higher die pressured than those of the polypropylene/Cloisite® 20A which have a less concentrated surface modifier. This is in accord with the viscosity of systems as is reported below.

Rheology:

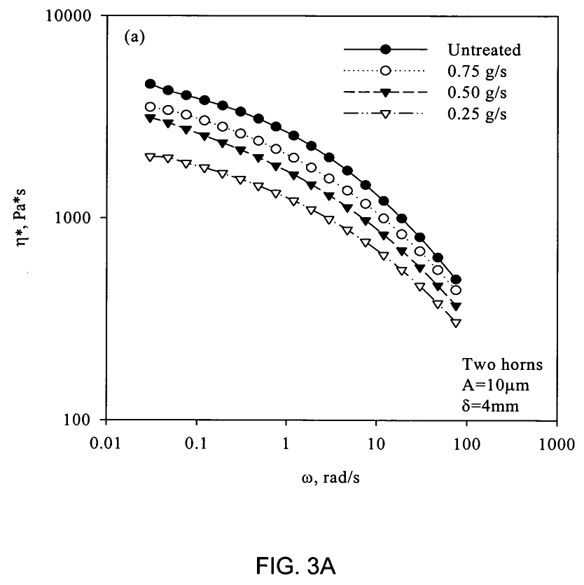

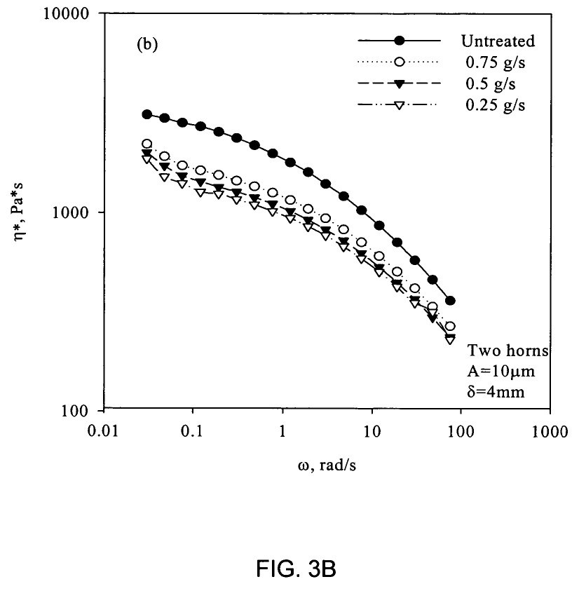

The steady shear rheological behavior of polypropylene containing 10% by weight of the total weight of the polymer mixture of Cloisite® 15A and 20A untreated and treated by ultrasound at different flow rates is shown in FIGS. 3A (Cloisite® 15A samples) and 3B (Cloisite® 20A samples).

Specifically, FIG. 3A is a graph of complex viscosity as a function of frequency for polypropylene containing 10% by weight of Cloisite® 15A based on the total weight of the polymer mixture, the samples being both untreated (one sample) and treated (three samples) by ultrasound at different flow rates, and FIG. 3B is a graph of complex viscosity as a function of frequency for polypropylene containing 10% by weight of Cloisite® 15A based on the total weight of the polymer mixture, the samples being both untreated (one sample) and treated (three samples) by ultrasound at different flow rates.

All the samples exhibit shear thinning as the frequency increases in the frequency range shown in FIGS. 3A and 3B. Furthermore, the viscosity decreases with decreasing flow rate, which can be attributed to increasing polymer degradation at longer residence time in the treatment zone. Interestingly, polypropylene/Cloisite® 15A filled systems show a gradual viscosity drop among the samples shown in FIG. 3A. In contrast, polypropylene/Cloisite® 20A nanocomposites exhibit almost one step viscosity drop from the untreated sample to the three treated samples. Comparison of melt viscosity values shows that the viscosity of the nanocomposites containing Cloisite® 15A that is subjected to higher level of modification is higher. This result correlates with the power consumption and die pressure measurements illustrated in FIGS. 1 and 2.

Structural Effects:

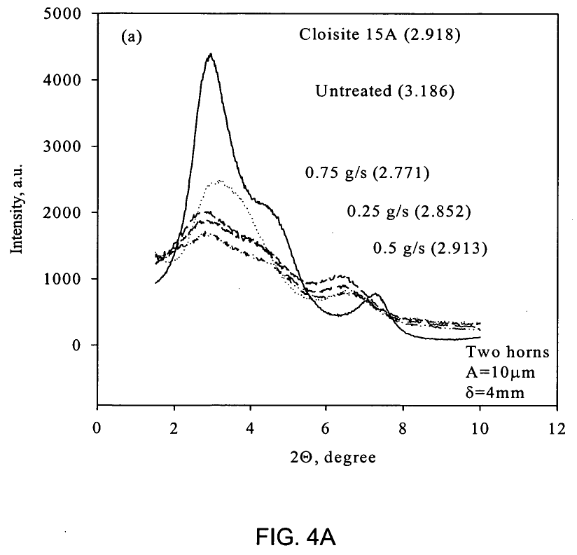

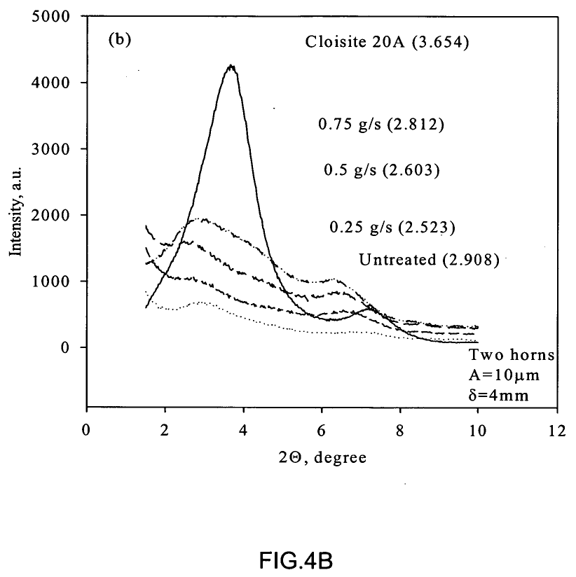

Turning to FIGS. 4A and 4B, the XRD patterns in FIGS. 4A and 4B illustrate the effect of ultrasound on the morphology of samples containing 2.5% by weight clay, based on the total weight of the polymer mixture, prepared at different flow rates. Based on the data shown in FIGS. 4A and 4B, the inter gallery distance of clays and nanocomposites can be calculated using Bragg's Law. Less change in the basal spacing of Cloisite® 15A based composites is observed. At the same time, the most significant increase in the inter-gallery distance is observed in polypropylene nanocomposites containing Cloisite® 20A. In particular, the basal spacing increases from 2.4 nm for pristine clay to 3.5 nm for intercalated clay in the nanocomposite prepared at a flow rate of 0.25 g/s.

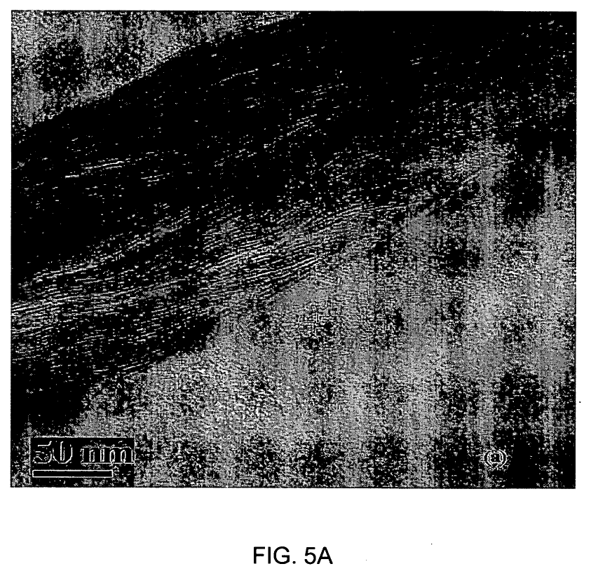

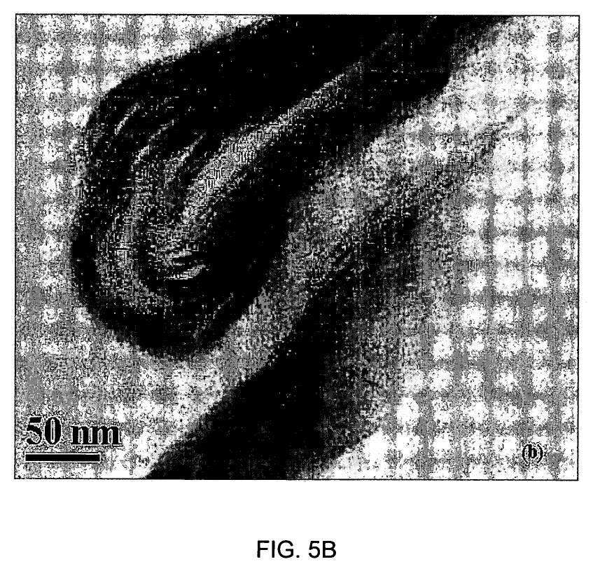

A significant decrease in intensity of d₀₀₁ peak suggests the presence of two distinct processes, namely, intercalation and partial exfoliation of the clay in the system. This data is supported further by TEM analysis, the results of which are shown in FIGS. 5A and 5B. Un-intercalated composites exhibit the structure depicted in FIG. 5A. As can be seen in FIG. 5A, individual tactoids of the layered clays are visible as regions of alternating narrow, dark and light bands within the particle. This regular structure is disrupted by ultrasonic treatment, resulting in the polymer entering into the inter gallery spacing wherein individual clay layers are dispersed in the polymer matrix (see FIG. 5B). Thus, transmission electron microscopy (TEM) analysis suggests that a partial exfoliation occurs under treatment with ultrasound. It should be noted that the length of ultrasound treatment in the sample of FIG. 5B is about 20 seconds. Thus, treatment time for successful intercalation and partial exfoliation is substantially lower (by about two orders of magnitude) than that achieved previously.

Mechanical Properties and Thermal Stability:

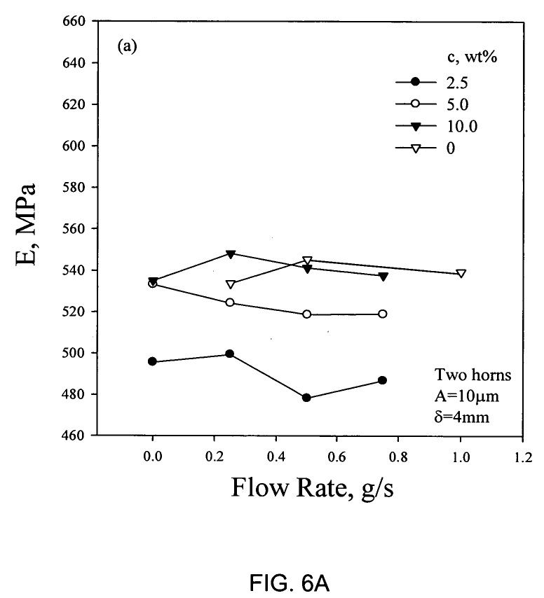

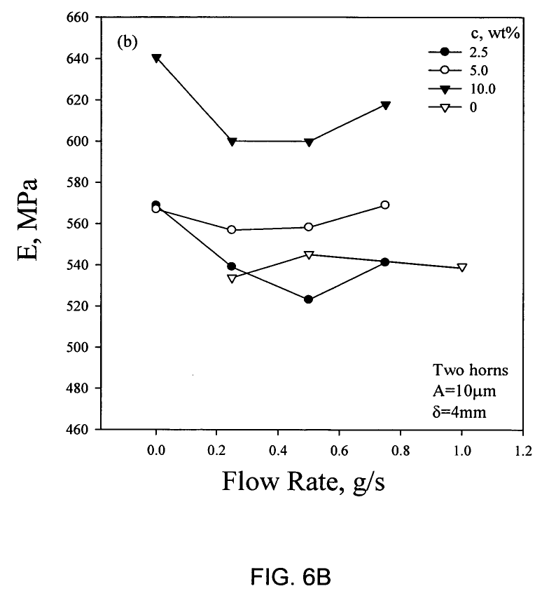

One would expect substantial improvement in the mechanical properties of intercalated/exfoliated nanocomposites when a high aspect ratio is realized. However, this is not the case. With increasing clay content, the Young's modulus does not change markedly compared to the neat polymer value, as is shown in FIGS. 6A and 6B. Specifically, FIG. 6A is a graph illustrating Young's modulus as a function of flow rate for polypropylene and polypropylene nanocomposites containing various concentrations of Cloisite® 15A, and FIG. 6B is a graph illustrating Young's modulus as a function of flow rate for polypropylene and polypropylene nanocomposites containing various concentrations of Cloisite® 20A. In addition, other mechanical properties are not substantially affected by the ultrasonic treatment of the present invention. This is because two competing processes simultaneously take place: intercalation/exfoliation of clay and polymer matrix degradation under the influence of ultrasound.

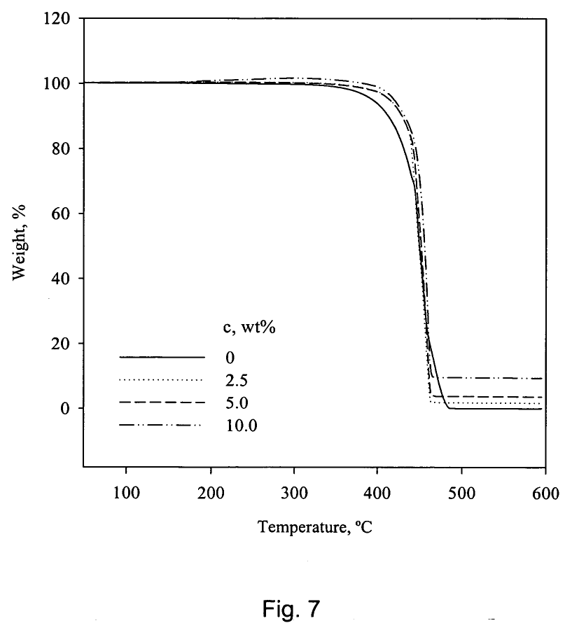

Results of thermal gravimetric analysis (TGA) of neat polypropylene and polypropylene nanocomposites are illustrated in FIG. 7. Specifically, FIG. 7 is a graph illustrating TGA curves for polypropylene and polypropylene nanocomposites containing various concentrations of Cloisite 20A that have been ultrasonically treated, in accordance with one embodiment of the present invention, at a flow rate of 0/25 g/s. As can bee seen from FIG. 7, the thermal stability of the polypropylene/clay nanocomposites are increased by about 40° C. versus polypropylene containing no clay (0% by weight).

Polypropylene Examples—Set II:

Materials and Experimental Procedures:

In the following examples polypropylene, made by Basell under trade name Profax® 6523, having an M_{w} equal to 351,000 is used to form nanocomposites in accordance with one embodiment of the present invention. Cloisite® 20A, a natural montmorillonites modified with a quaternary ammonium salt with a cation exchange capacity of 95 meq/100 g, is utilized. Polypropylene/clay nanocomposites using 2.5% by weight Cloisite® 20A, based on the total weight of the polymer mixture, are prepared as detailed below.

A two stage process is utilized to produce the desired polypropylene/clay nanocomposites. In the first stage a co-rotating twin screw extruder (JSW Labotex 30) is used to compound polypropylene and clay. The screw speed is set at 240 rpm and zone temperatures of 100/190/180/180/175/175/175/190° C. are used. The extrudates are water-cooled and pelletized. In the second stage the material is treated with ultrasound energy (20 KHz) in the molten state in a single screw extruder. Two ultrasound horns with 4 mm gap size and 10 μm ultrasound amplitude are used. Three different flow rates of the material (0.25, 0.5, and 0.75 g/s) are realized to vary residence time. Also used to produce polypropylene/Cloisite® 20A nanocomposites are starved and flood fed single stage processes utilizing a single screw compounding extruder.

Using a Rigaku X-ray machine operated at 40 kV and 150 mA, X-ray diffraction (XRD) patterns are obtained to determine the mean interlayer spacing of the (001) plane (d₀₀₁) for the organoclays and the nanocomposites containing the above-mentioned polypropylene. Transmission electron microscopy (TEM) is used to confirm the morphology development estimated by XRD. Ultrathin sections of specimens are cut by cryoultramicrotome below the glass transition temperature of the polypropylene, to ascertain the rigidity of the specimen, using a Reichert Ultracut's low-temperature sectioning system equipped with a diamond knife. Thin sections of specimen (approximately 70 nm) are transferred to a copper grid. A transmission electron microscopy (TECNAI 12, Philips) operated at 120 kV is used to take pictures of the specimens.

Tensile bars are obtained by Van Dorn 55 HPS 2.8F injection molding machine under the following processing conditions: a melt temperature of 190° C., a mold temperature of 25° C., an injection speed of 40 mm/s, an injection pressure of 10 MPa, a holding time of 2 seconds, and a total cycle time of 30 seconds. Tensile measurements on the injection molded samples of the above-mentioned nanocomposites are performed according ASTM D-638-00 using an Instron test machine, Model 5567. Tests are carried out at a crosshead speed of 50 mm/min and a 1 kN load cell without use of an extensiometer. All tests are performed at room temperature and the results are the average of five measurements. The highest value of standard deviation is about 11%. Also the rheological properties of nanocomposites are measured at 200° C. by ARES (Advanced Rheometric Expansion System). The geometry is a parallel plate with 25 mm diameter and 1.9 mm gap size.

Process Characteristics:

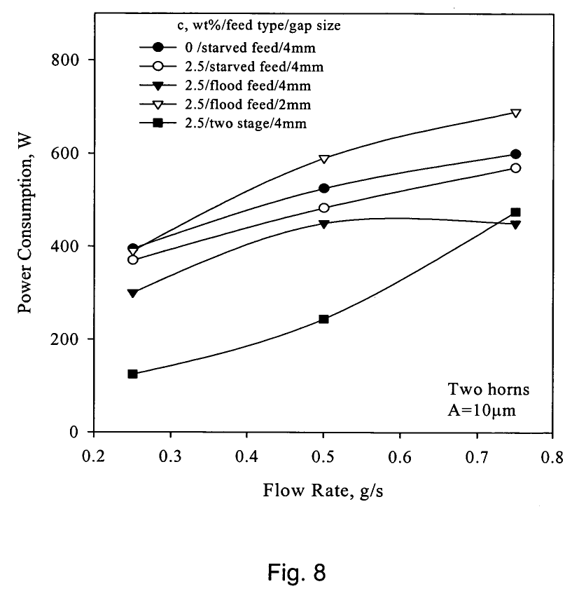

The recorded power consumption is the total power consumption, a part of which is dissipated as heat while a part is utilized to disperse clay filler and promote polymer intercalation into the clay inter gallery spacing. While not wishing to be bound to any one theory, it is not possible to determine exactly what proportion of the power is dissipated as heat and exactly what portion of the power is utilized to disperse the clay filler and promote polymer intercalation into the clay inter gallery spacing. The only thing that can be recorded is the initial power consumption of the system when the ultrasound horn is at work without a load and this loss is subtracted from the recorded values of power consumption to give the values shown in FIG. 8. Specifically, FIG. 8 is a graph of power consumption as a function of flow rate for both neat polypropylene and polypropylene/Cloisite® 20A nanocomposites obtained by single stage processes (starved or flood fed) and a two stage process.

An increase in the flow rate leads to an increase in the power consumption. This is an indication that more energy is being transmitted into the system at higher flow rates. Clearly, the treatment of pure polypropylene requires higher energy than that of the nanocomposites at the gap size of 4 mm. With a reduction in the gap size the power consumption increases due to the increase in the strain amplitude imposed on the polymer melt.

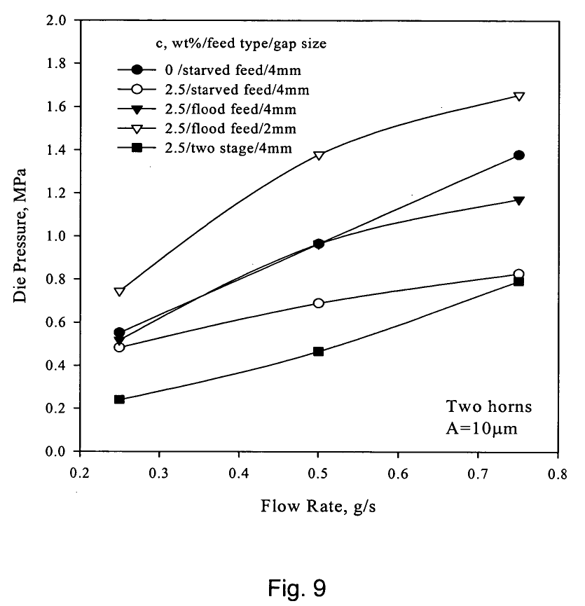

Turning to FIG. 9, FIG. 9 is a graph of die pressure as a function of flow rate for neat polypropylene and polypropylene/Cloisite® 20A nanocomposites obtained by single stage processes (starved or flood fed) and a two stage process. It can be seen from FIG. 9 that the die pressure increases as the flow rate increases. This is because the die pressure characterizes the resistance to flow and it is a function of the average residence time of the polymer (or polymer composite) in the treatment zone. Thus, the residence time is inversely proportional to the melt flow rate. Therefore, due to the longer residence time the effect of ultrasound in a larger gap should be expected to be greater. However, for a larger gap at the same amplitude, the strain amplitude is lower and determines the effect of ultrasound on polymers. Evidently, due to the increase of the strain amplitude, the effect of ultrasonic amplitude on the reduction of the melt viscosity is much stronger at smaller gaps than at larger gaps, even though the residence time is shorter in smaller gaps. This is in accordance with the viscosity of systems as is reported below.

Rheology:

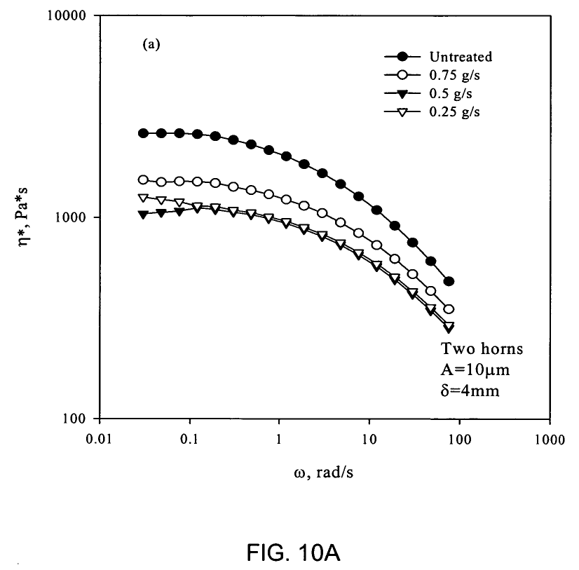

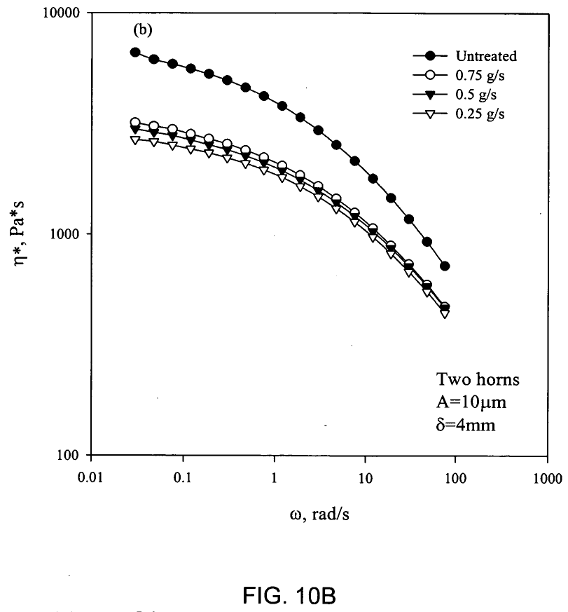

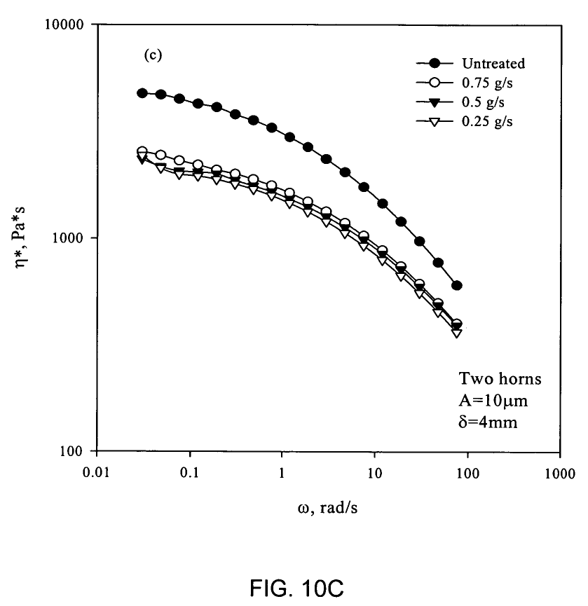

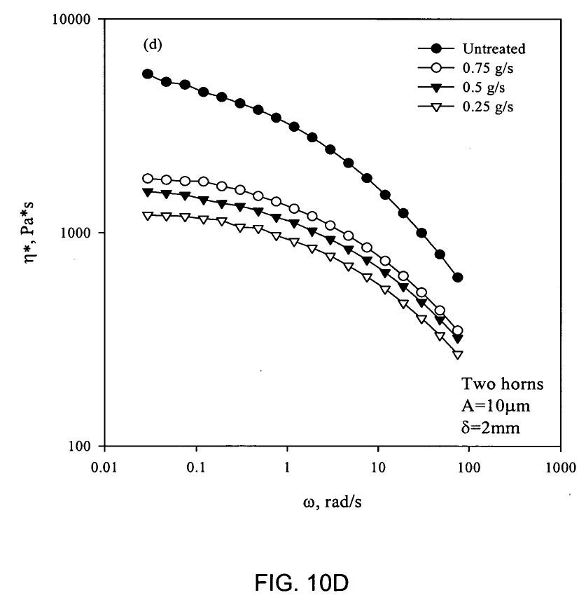

The complex viscosity behavior of polypropylene containing 2.5% by weight Cloisite® 20A untreated and treated by ultrasound at different flow rates is shown in FIGS. 10A to 10D. Specifically, FIG. 10A is a graph of complex viscosity as a function of frequency for both treated and untreated polypropylene nanocomposites containing 2.5% by Cloisite® 20A prepared by a two stage process; FIG. 10B is a graph of complex viscosity as a function of frequency for both treated and untreated polypropylene nanocomposites containing 2.5% by Cloisite® 20A prepared by a single stage starved feeding process; FIG. 10C is a graph of complex viscosity as a function of frequency for both treated and untreated polypropylene nanocomposites containing 2.5% by Cloisite® 20A prepared by a single stage flood feeding process with a gap size of 4 mm; and FIG. 10D is a graph of complex viscosity as a function of frequency for both treated and untreated polypropylene nanocomposites containing 2.5% by Cloisite® 20A prepared by a single stage flood feeding process with a gap size of 2 mm.

All the samples in FIGS. 10A to 10D exhibit shear thinning as the frequency increases in the frequency range shown in FIGS. 10A to 10D. Furthermore, the viscosity decreases with decreasing flow rate, which can be attributed to increasing polymer degradation at longer residence times in the treatment zone. Nanocomposites that are prepared using a single stage process exhibit higher viscosity values in the measured range. This supports the expectation of less polymer degradation while switching from the two stage process to the single stage process. However, a decrease in the gap size leads to a significant drop in viscosity compared to that of the two stage process. This correlates with the power consumption and die pressure measurements shown in the graphs of FIGS. 8 and 9.

Structural Effects:

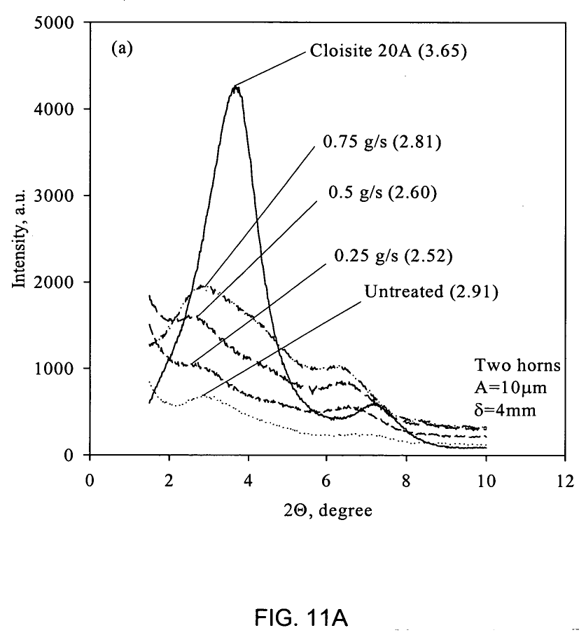

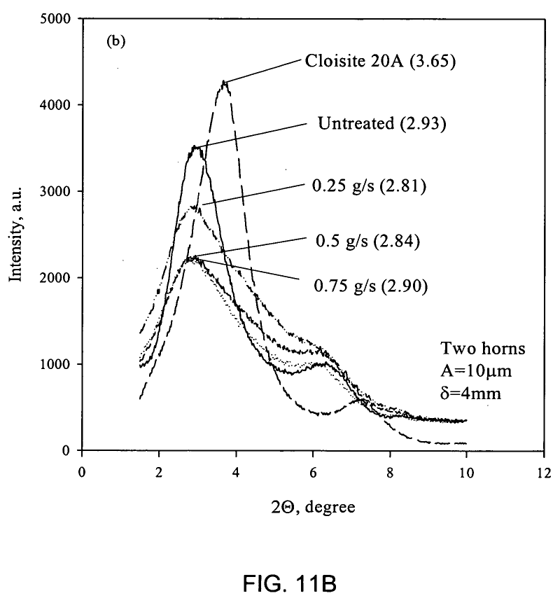

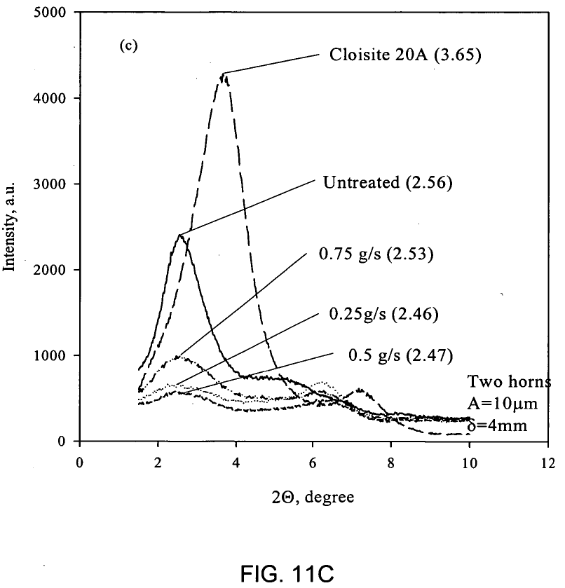

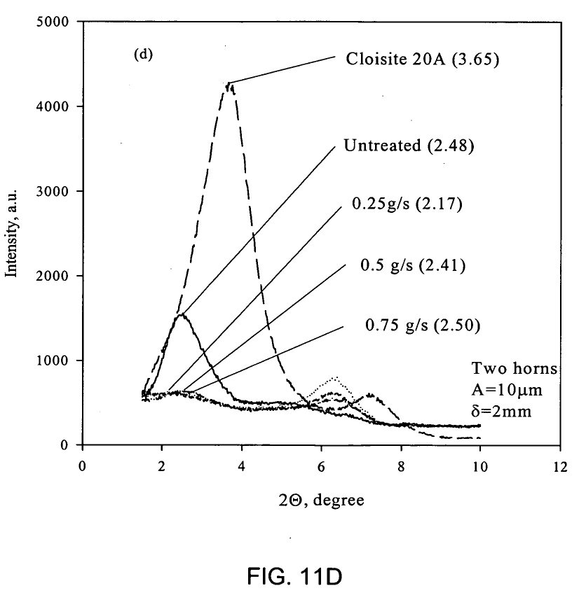

The XRD patterns in FIGS. 11A to 11D illustrate the effect of ultrasonic treatment on the morphology of polypropylene/clay nanocomposite, prepared at varying flow rates, where the clay is present in the amount of 2.5% by weight clay. Based on this data the inter gallery distance of clays and nanocomposites is calculated using Bragg's Law. Less change in the basal spacing of Cloisite® 20A based composites is observed for the single stage starved feeding process (FIG. 11B). At the same time, the most significant increase in the inter-gallery distance is observed in the nanocomposites obtained by the single stage flood feeding process with a 2 mm gap, and a flow rate of 0.25 g/s (FIG. 11D).

In particular, the basal spacing increases from 2.4 nm for pristine clay to 4.1 nm for intercalated clay in the nanocomposite obtained at the above-mentioned conditions. A significant decrease in intensity of d₀₀₁ peak suggests the presence of two distinct processes, namely, intercalation and partial exfoliation of the clay in the system. It should be noted that the length of ultrasound treatment in this particular case is about 20 seconds. Thus, treatment time for successful intercalation and partial exfoliation is substantially lower (by about two orders of magnitude) than that achieved previously.

Mechanical Properties:

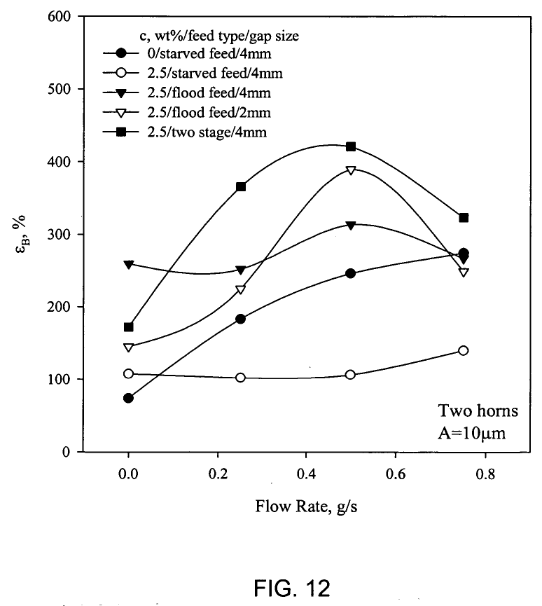

One would expect substantial improvement in the mechanical properties of intercalated/exfoliated nanocomposites when a high aspect ratio is realized. However, this is not the case. In fact, the elongation at break and toughness (the area under the stress-strain curve) are significantly increased in ultrasonically treated nanocomposites containing 2.5% by weight Cloisite® 20A prepared at flow rates of 0.25 and 0.5 g/s with two stage and single stage processes (2 mm gap), as can be seen from the data presented in FIG. 12 indicating the elongation at break as a function of flow rate. Clearly, this increase is achieved at residence times when intercalation and partial exfoliation are observed by XRD. In addition, other mechanical properties are not substantially affected by the ultrasonic treatment of the present invention. This is because two competing processes simultaneously take place: intercalation/exfoliation of clay and polymer matrix degradation under the influence of ultrasound.

High Density Polyethylene (HDPE) Examples:

Materials and Experimental Procedures:

High density polyethylene (HDPE) is obtained and used as is (HMN 4550-03-Marlex from Phillips). Cloisite® 20A, a natural montmorillonites modified with a quaternary ammonium salt with a cation exchange capacity of 95 meq/100 g, and d-spacing of 2.42 nm is utilized. HDPE/clay nanocomposites with varying clay contents of 2.5%, 5.0%, 10.0% by weight clay, based on the total weight of the polymer mixture, are prepared by a single screw compounding extruder with an ultrasonic attachment, which produced ultrasound at a frequency of 20 KHz and amplitudes of 5 μm, 7.5 μm and 10 μm.

It should be noted that the present invention is not limited to an ultrasound frequency of 20 KHz. Rather any suitable frequency in the range of about 15 KHz to about 200 MHz, or from about 20 KHz to about 100 MHz, or from about 25 KHz to about 50 MHz, or even from about 15 KHz to about 40 KHz, can be used in conjunction with any process of the present invention.

Furthermore, in one embodiment, any polymer nanocomposite of the present invention can be/is subjected to ultrasound energy, as discussed above, for at least about 1 second to less than 60 seconds, or from about 2.5 seconds to about 40 seconds, or from about 5 seconds to about 30 seconds, or even from about 7.5 seconds to about 20 seconds. In another embodiment, any polymer nanocomposite of the present invention can be/is subjected to ultrasound energy, as discussed above, for less than 60 seconds, less about 55 seconds, less than about 50 seconds, less than about 45 seconds, less than about 40 seconds, less than about 35 seconds, less than about 30 seconds, less than about 25 seconds, less than about 20 seconds, less than about 15 seconds, and even less than about 10 seconds.

In one embodiment of the present invention, the polymer nanocomposite is subjected to any suitable energy frequency (e.g., ultrasound energy) while simultaneously under pressure. Again, this embodiment can be applied to any of the processes disclosed herein. In one embodiment, the pressure to which the polymer nanocomposite is subject is in the range from about 30 psi to about 5,000 psi, or from about 50 psi, to about 4,000 psi, or from about 75 psi to about 3,000 psi, or from about 100 psi to about 2,000 psi, or from about 250 psi to about 1,500 psi, or from about 400 psi to about 1,000 psi, or even from about 500 psi to about 750 psi.

The screw speed is set at 100 rpm and temperatures of 180° C., 190° C. and 200° C. are used from the feeding section to the die zones, respectively. The gap in the slit die is 4 mm. The material is ultrasonically treated in the molten state at three different flow rates of 0.25 g/s, 0.50 g/s and 0.75 g/s, corresponding to residence times of 21 seconds, 10 seconds and 7 seconds, respectively.

Tensile bars are obtained by Van Dorn 55 HPS 2.8F injection molding machine under the following processing conditions: a melt temperature of 190° C., a mold temperature of 40° C., an injection speed of 40 mm/s, an injection pressure of 13.8 MPa, a holding time of 20 seconds, and a cooling time of 20 seconds. Tensile strength measurements of the above-mentioned nanocomposites are performed according ASTM D-638-00 using an Instron test machine, Model 5567. Tests are carried out at a crosshead speed of 50 mm/min and a 1 kN load cell without use of an extensiometer. All tests are performed at room temperature and the results are the average of five measurements. The rheological properties are measured by ARES, with dynamic mode of frequency sweep (strain control) process at 200° C. The geometry is a parallel plate a diameter of 25 mm and a gap size of 1.7 mm. Thermal behaviors of the nanocomposites are measured by Differential Scanning Calorimeter (DSC) (Model Universal V3.0G, TA Instruments). Samples are heated from room temperature to 250° C. at a rate of 20° C./minute under a nitrogen atmosphere.

Process Characteristics:

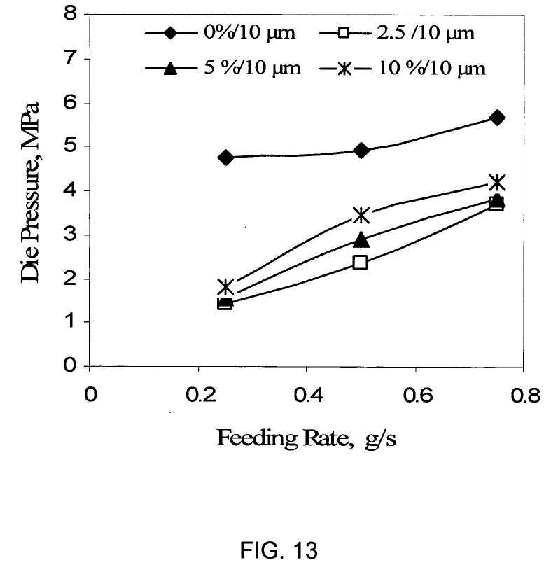

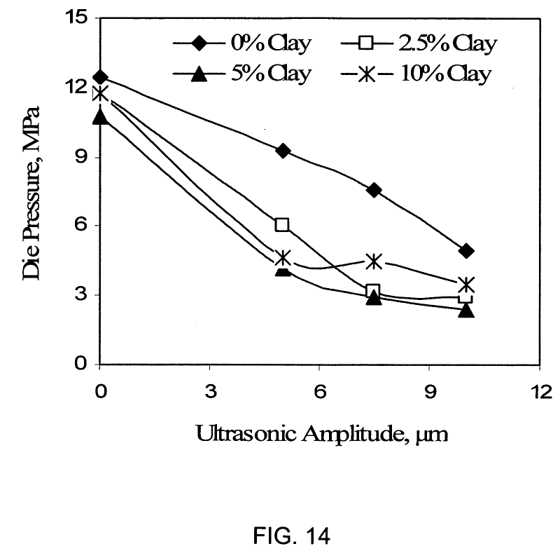

The die pressure of the single screw extruder and the power consumption due to ultrasonic treatment are recorded. It is observed that the die pressure increases with an increase in the flow rate of HDPE/clay nanocomposites at all concentrations of clay and an amplitude of 10 μm (FIG. 13). This is because the die pressure characterizes the resistance to flow and it is a function of the average residence time of the polymer (or polymer composite) in the treatment zone. Thus, the residence time is inversely proportional to the melt flow rate and directly proportional to the die gap. It is also observed that, the die pressure decreases substantially with the application of ultrasound and that with increasing amplitude, the pressure decreases further (see FIG. 14). While not wishing to be bound to any one theory, this may be due to reduction in friction between the HDPE/clay particles and the die walls due to ultrasonic vibration. It is also observed that the die pressure of neat polymer is always more than of the polymer/clay nanocomposites.

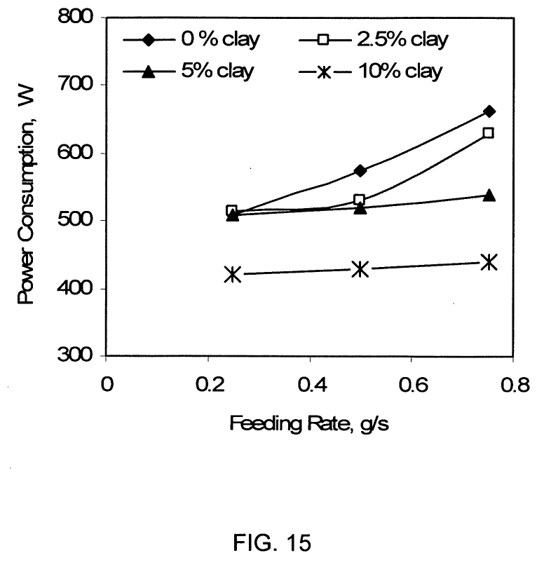

The recorded power consumption due to the ultrasound treatment is the total power consumption, a part of which is dissipated as heat while a part is utilized to disperse clay filler and promote polymer intercalation into the clay inter gallery spacing. FIG. 15 is a graph of power consumption as a function of feeding rate at different concentrations of Cloisite® 20A in HDPE, including 0% by weight clay, at an ultrasonic amplitude of 10 μm. As can be seen from FIG. 15, power consumption increases with an increase in the feeding rate for all concentrations of Cloisite® 20A. As a result, it can be determined that more energy is being transmitted into the system at a higher feeding rate. It is also observed that the treatment of pure HDPE requires higher energy than that of the HDPE/clay nanocomposites.

Mechanical Properties:

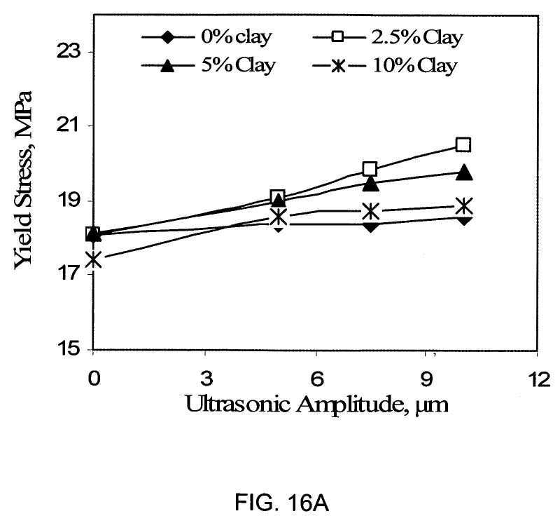

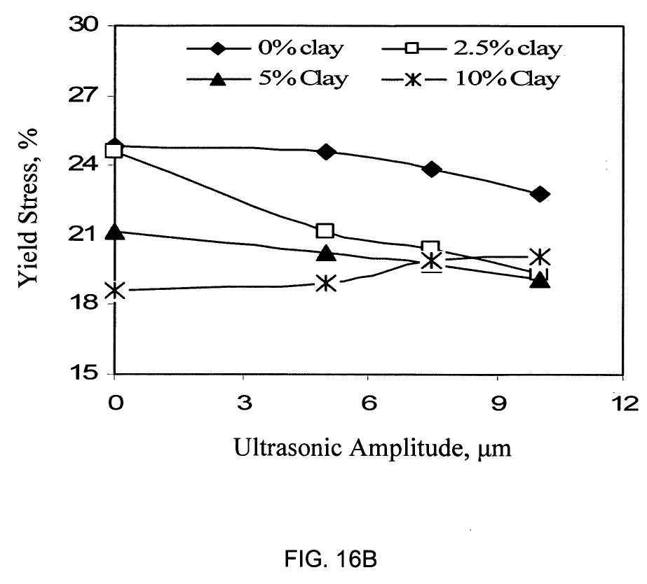

The mechanical properties, including Young's modulus, elongation at break, toughness, yield stress and yield strain of all the nanocomposites prepared as noted above, together with the corresponding values of virgin (or neat, or pure) polymer are plotted in FIGS. 16A, 16B, 17 and 18 and are summarized in Table 1.

TABLE 1
Comparative Data of Mechanical Properties
of HDPE/Clay Nanocomposites

| | Young's | Elongation | | | |
|---|---|---|---|---|---|
| Sample, | Modulus, | at Break | Toughness, | Yield | Yield Stress |
| (%/μm) | (MPa) | (%) | (MPa) | Strain (%) | (MPa) |
| 0/0 | 317 | 908 | 142.7 | 24.8 | 18.1 |
| 2.5/0 | 324 | 679 | 82.4 | 24.6 | 18.1 |
| 5/0 | 459 | 487 | 62.1 | 21.1 | 18.1 |
| 10/0 | 445 | 193 | 23.9 | 18.6 | 17.4 |
| 5/5 | 423 | 887 | 112.4 | 20.2 | 19.0 |
| 5/7.5 | 400 | 973 | 132.3 | 19.7 | 19.5 |
| 5/10 | 425 | 835 | 109.5 | 19.1 | 19.8 |

As can be seen from FIGS. 16A, 16B, 17 and 18, and Table 1, the Young's modulus of the nanocomposites increases significantly with an increase in clay loading and decreases slightly with an increasing ultrasound amplitude. The yield stress (FIG. 16A) of the ultrasonically treated nanocomposites is more than that of the untreated samples. The yield strain (FIG. 16B) of the untreated nanocomposites generally decreases monotonically with an increase in clay concentration and also generally decrease with an increase in ultrasonic amplitude.

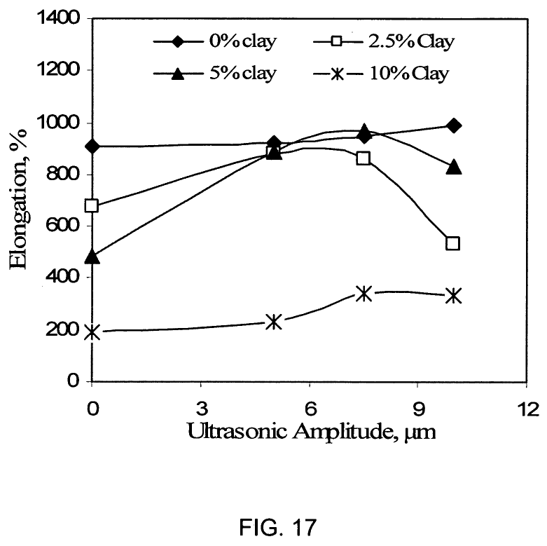

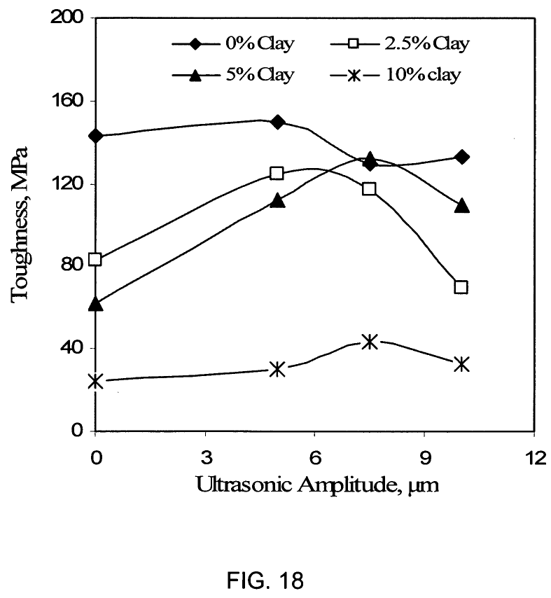

Due to their rigidity, the clay filler particles cannot be deformed by external stress in the specimen but act only as stress concentrators during deformation process. The elongation at break (FIG. 17) and toughness (FIG. 18) of the nanocomposites decrease tremendously with increasing clay content. The elongation at break and toughness increase more than two times for the ultrasonically treated nanocomposites compared to the untreated samples. Therefore, ultrasound plays a vital role in dispersion, intercalation, and partial exfoliation of clay in HDPE, creating a strong interfacial adhesion with the matrix and increases extensibility during tensile deformation.

Rheological Properties:

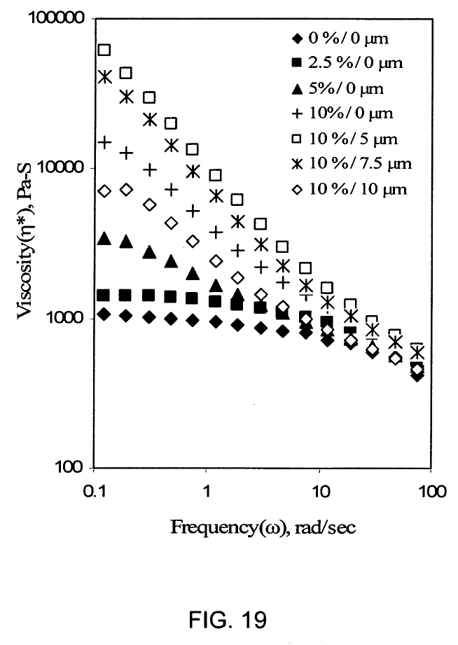

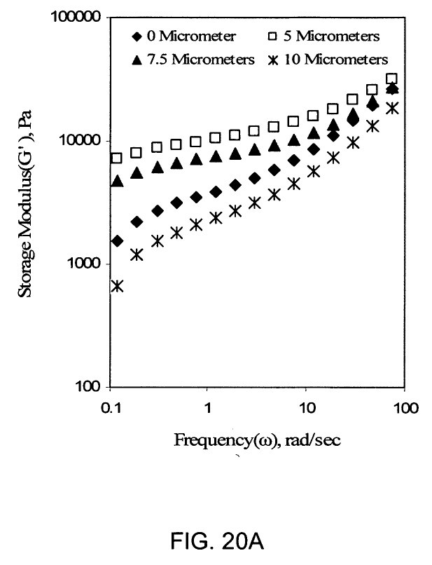

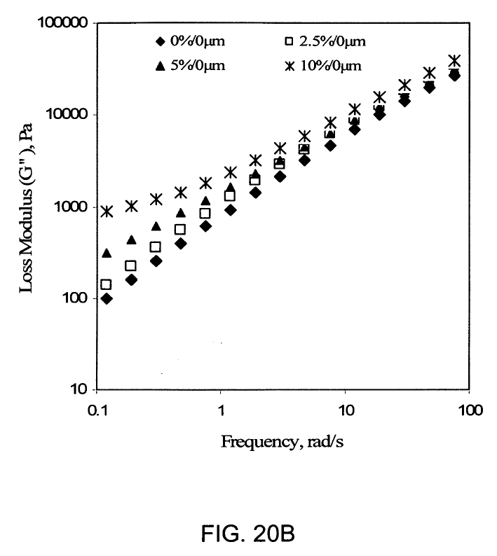

The complex viscosity of nanocomposites as a function of clay content and ultrasonic amplitude at 10% clay is illustrated in the graph of FIG. 19. It is observed that the complex viscosity of the nanocomposites increases with an increase in clay concentration. The complex viscosity of the nanocomposites further increases with ultrasonic treatment and attains its maximum level at an amplitude of 5 μm. The complex viscosity decreases at higher amplitudes. Similar trends are obtained for all concentrations of clay. The great enhancement of the complex viscosities of the ultrasonically treated nanocomposites can be attributed to the nanoscale dispersion, intercalation and partial exfoliation of clay within the HDPE, which improves the dispersion, intercalation, partial exfoliation and/or compatibility between the polymer matrix and the layered silicate. Storage (G′) and loss (G″) moduli increase with increasing clay concentration (see FIGS. 20A and 20B).

After treatment with ultrasound these properties further increase at 5 μm but decreased at high amplitudes of ultrasound. The results of storage moduli at different amplitudes of ultrasound and the results of loss moduli at different concentrations of clay are shown in FIGS. 20A and 20B, respectively. At low frequencies, G′ and G″ functions are widely separated, while they are slightly separated at high frequencies (see FIGS. 17 and 18). After ultrasonic treatment, a sudden increase is obtained at an amplitude of 5 μm and slowly decreases at higher amplitudes. This is believed to be a result of the improved compatibilization effect of the ultrasound on the HDPE/clay nanocomposites.

Although the invention has been described in detail with particular reference to certain embodiment detailed herein, other embodiments can achieve the same results. Variations and modifications of the present invention will be obvious to those skilled in the art and the present invention is intended to cover in the appended claims all such modifications and equivalents.

What is claimed is:

1. A continuous method of forming a polymer nanoparticle composite, the method comprising:
(a) combining at least one polymer and at least one type of nanoparticles to form a polymer nanoparticle mixture; and
(b) subjecting the polymer nanoparticle mixture to an energy source, wherein the energy source has a frequency in the range of about 15 KHz to about 200 MHz,
wherein the polymer nanoparticle mixture is in a melted state and under pressure in Step (b), and wherein the polymer nanoparticle mixture is subjected to the energy source for less than 60 seconds.

2. The method of claim 1, wherein the at least one polymer is at least one thermoplastic polymer.

3. The method of claim 2, wherein the at least one thermoplastic polymer is selected from polyolefin-based polymers, polystyrene-based polymers, polycarbonate polymers, polyamide polymers, or a mixture of two or more thereof.

4. The method of claim 2, wherein the at least one thermoplastic polymer is selected from a polyethylene homopolymer, a polyethylene copolymer, a polypropylene homopolymer, or a polypropylene copolymer.

5. The method of claim 1, wherein the at least one polymer is at least one polyolefin polymer.

6. The method of claim 5, wherein the at least one polyolefin polymer is selected from polyethylene, polypropylene, polybutenes, polyisoprene, and co-polymers of two or more different polyolefin polymers.

7. The method of claim 1, wherein the at least one polymer is selected from polyethylene, polypropylene, or mixtures thereof.

8. The method of claim 1, wherein the at least one type of nanoparticles are selected from one or more clays, organoclays, modified clays, or mixtures of two or more thereof.

9. The method of claim 1, wherein the at least one type of nanoparticles are selected from one or more clays or organoclays.

10. The method of claim 1, wherein the at least one type of nanoparticles are selected from one or more montmorillonite clays, kaolin clays, calcium carbonate, titanium dioxide, talc, zirconium dioxide, zinc oxide, calcium silicate, aluminum silicate, calcium sulfate, alumina trihydrate, and mixtures of two or more thereof.

11. The method of claim 1, wherein the at least one type of nanoparticles are selected from montmorillonite clays.

12. The method of claim 1, wherein the polymer nanoparticle mixture further comprises at least one traditional filler.

13. The method of claim 1, wherein the amount of nanoparticles in the polymer nanoparticle mixture is in the range of about 0.1% to about 30% of the total weight of the polymer mixture.

14. The method of claim 13, wherein the amount of nanoparticles in the polymer nanoparticle mixture is in the range of about 2.5% to about 10% of the total weight of the polymer mixture.

15. The method of claim 1, wherein the size of the nanoparticles in the polymer nanoparticle mixture is in the range of about 1 nanometer to about 20,000 nanometers.

16. The method of claim 15, wherein the size of the nanoparticles in the polymer nanoparticle mixture is in the range of about 10 nanometers to about 500 nanometers.

17. A polymer composite made by the process of claim 1.

18. A continuous method of forming a polymer nanoparticle composite, the method comprising:
(a) combining at least one polymer and at least one type of nanoparticles to form a polymer nanoparticle mixture; and
(b) subjecting the polymer nanoparticle mixture to an energy source, wherein the energy source has a frequency in the range of about 15 KHz to about 200 MHz,
wherein the polymer nanoparticle mixture is in a melted state and under pressure in Step (b), and wherein the polymer nanoparticle mixture is subjected to the energy source for less than about 30 seconds.

19. The method of claim 18, wherein the at least one polymer is at least one thermoplastic polymer selected from polyolefin-based polymers, polystyrene-based polymers, polycarbonate polymers, polyamide polymers, or a mixture of two or more thereof.

20. The method of claim 18, wherein the at least one polymer is at least one polyolefin polymer selected from polyethylene, polypropylene, polybutenes, polyisoprene, and co-polymers of two or more different polyolefin polymers.

21. The method of claim 18, wherein the at least one polymer is selected from polyethylene, polypropylene, or mixtures thereof.

22. The method of claim 18, wherein the at least one type of nanoparticles are selected from one or more clays, organoclays, modified clays, or mixtures of two or more thereof.

23. The method of claim 18, wherein the at least one type of nanoparticles are selected from one or more clays or organoclays.

24. The method of claim 18, wherein the at least one type of nanoparticles are selected from one or more montmorillonite clays, kaolin clays, calcium carbonate, titanium dioxide, talc, zirconium dioxide, zinc oxide, calcium silicate, aluminum silicate, calcium sulfate, alumina trihydrate, and mixtures of two or more thereof.

25. The method of claim 18, wherein the at least one type of nanoparticles are selected from montmorillonite clays.

26. The method of claim 18, wherein the amount of nanoparticles in the polymer nanoparticle mixture is in the range of about 0.1% to about 30% of the total weight of the polymer mixture.

27. The method of claim 26, wherein the amount of nanoparticles in the polymer nanoparticle mixture is in the range of about 2.5% to about 10% of the total weight of the polymer mixture.

28. The method of claim 18, wherein the size of the nanoparticles in the polymer nanoparticle mixture is in the range of about 1 nanometer to about 20,000 nanometers.

29. The method of claim 28, wherein the size of the nanoparticles in the polymer nanoparticle mixture is in the range of about 10 nanometers to about 500 nanometers.

30. A polymer composite made by the process of claim 18.
